(19) United States
(12) Patent Application Publication
(10) Pub. No.: US 2024/0230887 A1
(43) Pub. Date: Jul. 11, 2024

(54) DRIVER-SPECIFIED OBJECT TRACKING

(71) Applicant: Arriver Software AB, Linköping (SE)

(72) Inventor: Annika LARSSON, Göteborg (SE)

(21) Appl. No.: 18/151,129

(22) Filed: Jan. 6, 2023

(51) Int. Cl. G01S 13/931

(52) U.S. Cl. CPC G01S 13/931; G01S 2013/9322; G01S 2013/9327

(57) ABSTRACT

A first user equipment (UE) may obtain a command comprising an indication of a driver-specified direction (DSD) from a driver of a vehicle. The first UE may adjust a priority of objects detected within a sensor area of a set of sensors based on the indication of the DSD. To adjust the direction of the set of sensor, the first UE may transmit, to a second UE, a signal including at least one of the indication of the DSD or a second indication of the sensor area. The first UE may transmit the signal using a V2X communication link with the second UE. The first UE may receive, from the second UE, a set of sensor results associated with the sensor area. The first UE may output a sensor report based on the received set of sensor results.

### TECHNICAL FIELD

The present disclosure relates generally to communication systems, and more particularly, to a system for sensing objects about a vehicle.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may obtain a command including an indication of a driver-specified direction (DSD) from a driver of a vehicle. The apparatus may adjust a priority of objects detected within a sensor area of a set of sensors based on the indication of the DSD.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example aspects of a sidelink slot structure.

FIG. 5 is a diagram illustrating example aspects of sidelink communication between devices, in accordance with aspects presented herein.

FIG. 6 is a diagram illustrating examples of resource reservation for sidelink communication.

FIG. 7 is a diagram illustrating example aspects of UEs having sensors that may be configured to sense objects about the UEs.

FIG. 8A is a diagram illustrating example aspects of a UE obtaining an indication of a driver-specified direction (DSD) from a driver of a vehicle.

FIG. 8B is a diagram illustrating example aspects of a UE monitoring objects within a sensor area.

FIG. 9A is a diagram illustrating an example of a UE configured to indicate a sensor area.

FIG. 9B is a diagram illustrating an example of a UE display configured to indicate a sensor area.

FIG. 10 is a connection flow diagram for a UE configured to sense objects within a sensor area of a plurality of UEs.

FIG. 11 is a flowchart of a method of wireless communication

FIG. 12 is another flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

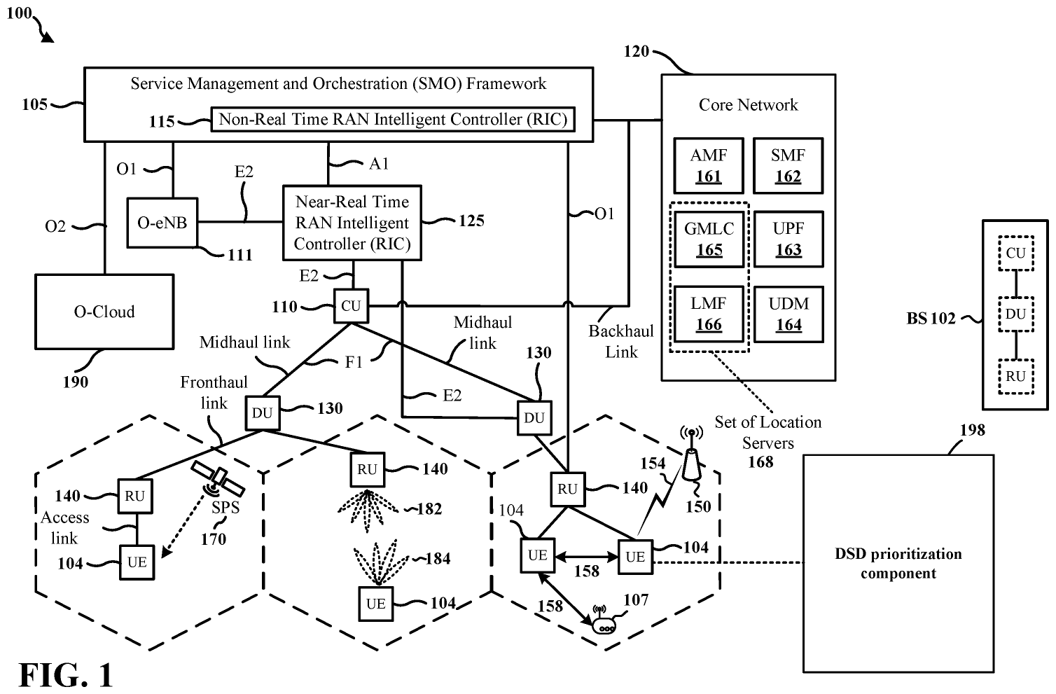

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

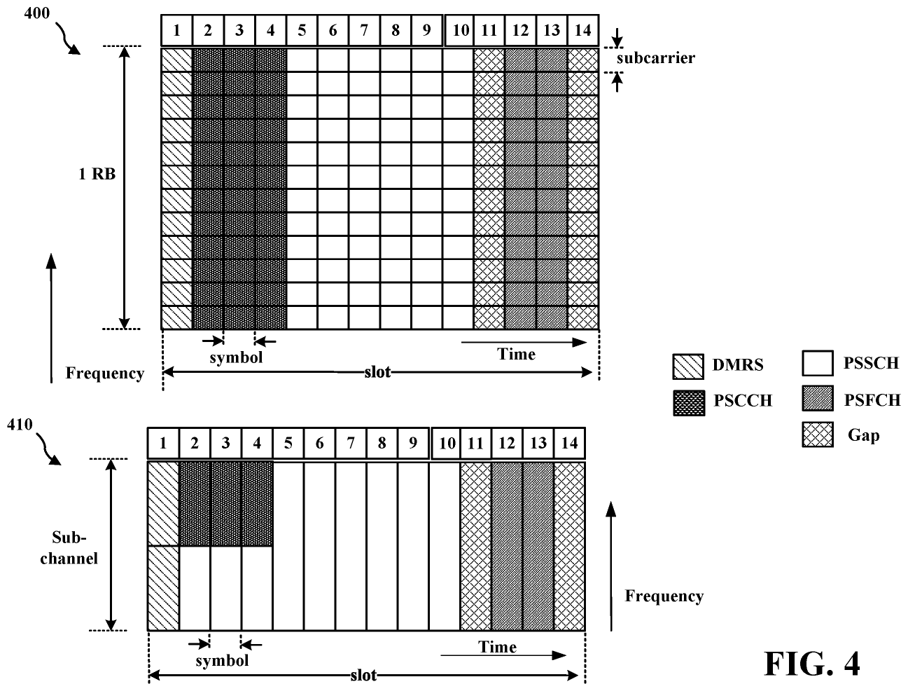

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a DSD prioritization component 198 that may be configured to obtain a driver-specified direction (DSD) from a driver of a vehicle. The DSD prioritization component 198 may be configured to adjust a priority of objects detected within a sensor area of a set of sensors based on the indication of the DSD. Although the following description may be focused on vehicle-to-everything (V2X) communication, the concepts described herein may be applicable to other similar areas, such as Internet of Things (IoT) communication. Although the following description may be focused on 5G NR, the concepts described herein may be applicable to other similar areas, such as LTE, LTE-A, CDMA, GSM, and other wireless technologies.

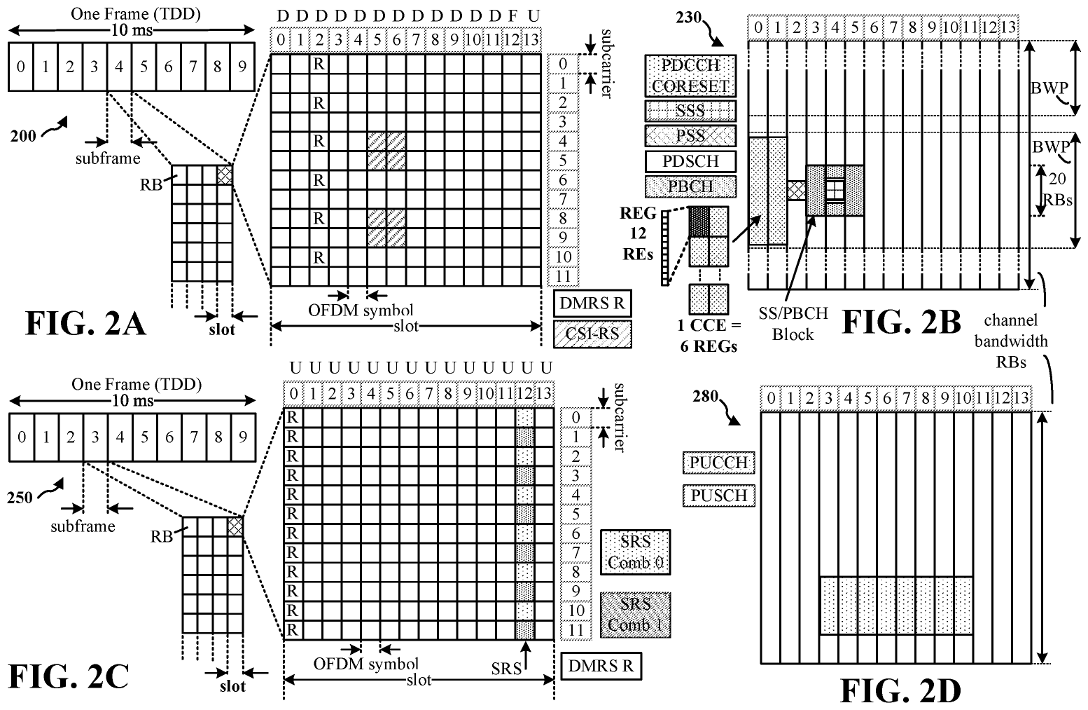

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

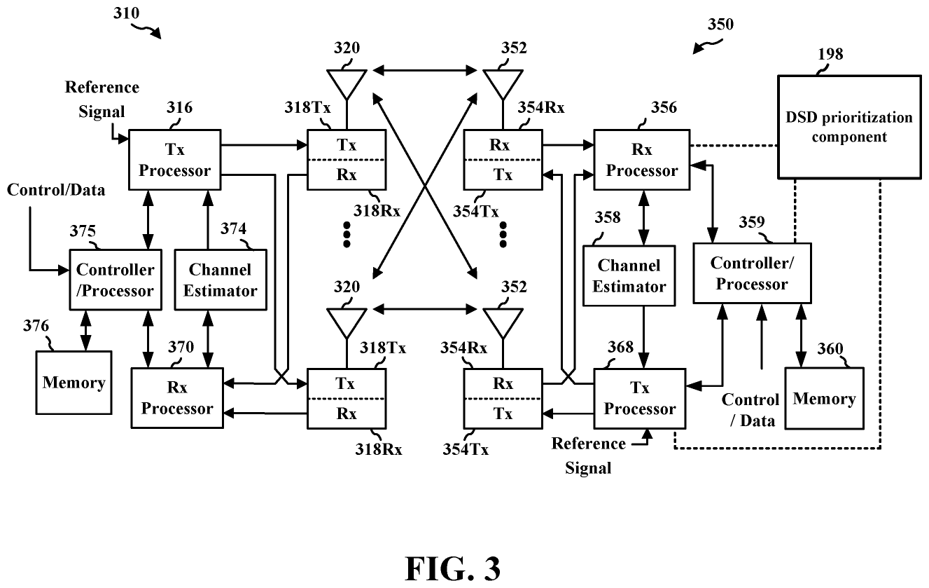

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the DSD prioritization component 198 of FIG. 1.

FIG. 4 includes diagrams 400 and 410 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

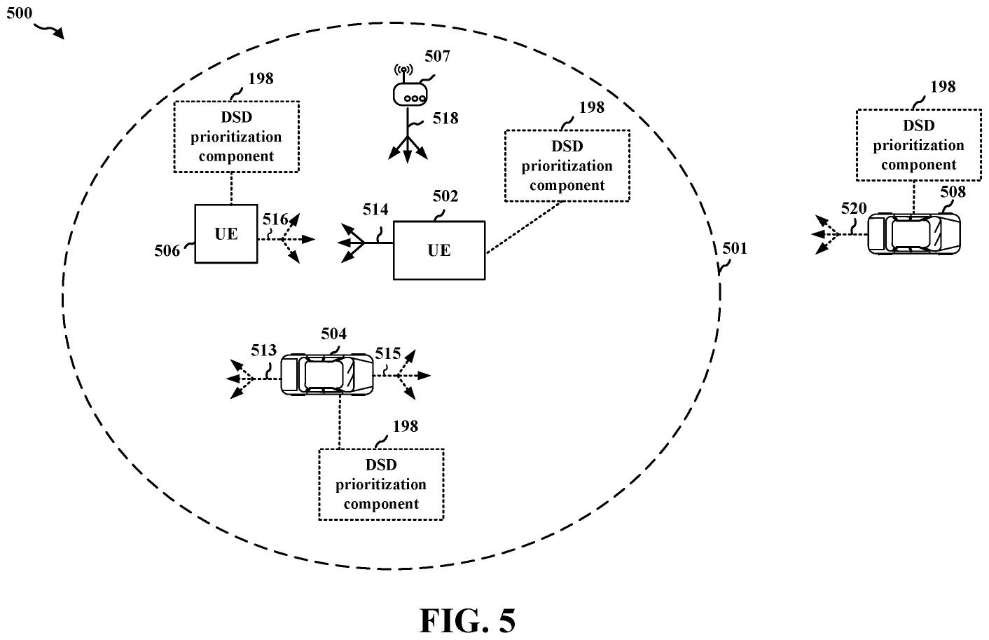

FIG. 5 illustrates a diagram 500 of sidelink communication between devices. The communication may be based on a slot structure including aspects described in connection with FIG. 5. For example, the UE 502 may transmit a sidelink transmission 514, e.g., including a control channel (e.g., PSCCH) and/or a corresponding data channel (e.g., PSSCH), that may be received by UEs 504, 506, 508. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 502, 504, 506, 508 may each be capable of sidelink transmission in addition to sidelink reception. Thus, UEs 504, 506, 508 are illustrated as transmitting sidelink transmissions 513, 515, 516, 520. The sidelink transmissions 513, 514, 515, 516, 520 may be unicast, broadcast or multicast to nearby devices. For example, UE 504 may transmit sidelink transmissions 513, 515 intended for receipt by other UEs within a range 501 of UE 504, and UE 506 may transmit sidelink transmission 516. Additionally, or alternatively, RSU 507 may receive communication from and/or transmit communication 518 to UEs 502, 504, 506, 508. One or more of the UEs 502, 504, 506, 508 or the RSU 507 may include a DSD prioritization component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices.

The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

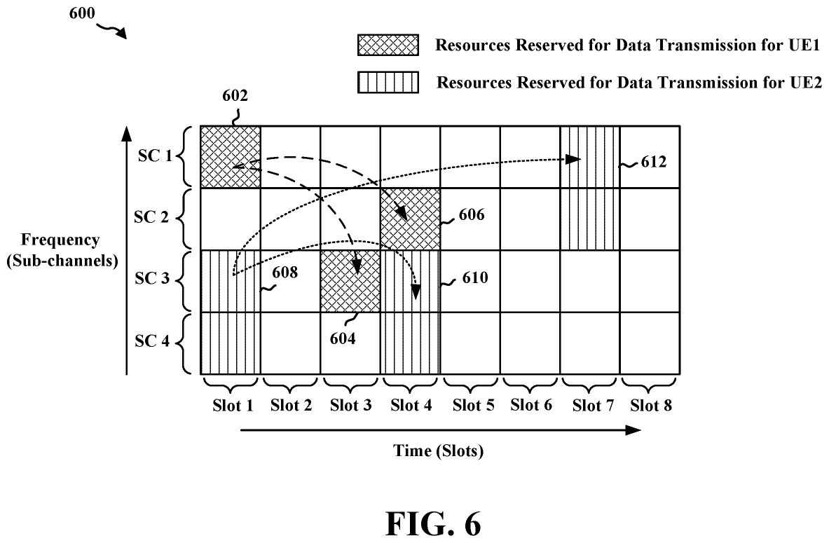

FIG. 6 is an example 600 of time and frequency resources showing reservations for sidelink transmissions. The resources may be included in a sidelink resource pool, for example. The resource allocation for each UE may be in units of one or more sub-channels in the frequency domain (e.g., sub-channels SC1 to SC4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 600, which provides 32 available resource blocks in total. This window may also be referred to as a resource selection window.

A first UE (“UE1) may reserve a sub-channel (e.g., SC 1) in a current slot (e.g., slot 1) for its initial data transmission 602, and may reserve additional future slots within the window for data retransmissions (e.g., 604 and 606). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 6 illustrates that a second UE (“UE2”) reserves resources in sub-channels SC 3 and SC4 at time slot 1 for a data transmission 608, and reserve a data transmission 610 at time slot 4 using sub-channels SC 3 and SC 4, and reserve a data transmission 612 at time slot 7 using sub-channels SC 1 and SC 2 as shown by FIG. 6. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 6 illustrates resources being reserved for an initial transmission and two retransmissions, the reservation may be for an initial transmission and a single transmission or just for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 6, the UE may transmit SCI reserving resources for data transmissions 608, 610, and 612.

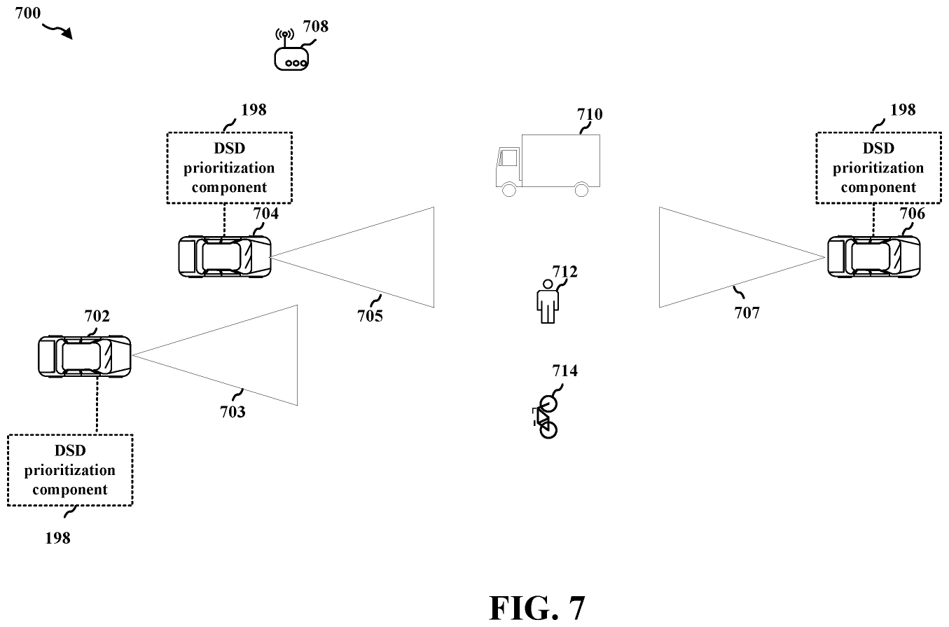

FIG. 7 is a diagram 700 illustrating an example of a set of UEs, such as the UEs 702, 704, and 706 configured to detect one or more of a set of objects, such as the objects 710, 712, and 714. The UEs may be configured to communicate with one another via a D2D communication link, such as sidelink or V2X. The UEs 702, 704, and 706 may have a set of sensors that may be used to sense objects outside of the vehicle. The UEs 702, 704, and 706 may have a set of sensors that may be used to sense a driver within the vehicle. The set of sensors may include at least one of a light detection and ranging (LIDAR) sensor, a radio detection and ranging (RADAR) sensor, a sound navigation and ranging (SONAR) sensor, a thermal sensor, a microphone, or a camera. The set of sensors of a UE may be configured to detect objects within a detection area about the UE. For example, the UE 702 may have a detection area within the detection direction 703, within which the UE 702 may detect an object, such as the object 710, the object 712, or the object 714. The UE 704 may have a detection area within the detection direction 705, within which the UE 704 may detect an object, such as the object 710, the object 712, or the object 714. The UE 706 may have a detection area within the detection direction 707, within which the UE 706 may detect an object, such as the object 710, the object 712, or the object 714.

The RSU 708 may coordinate communications between the UEs 702, 704, and 706. In one aspect, the UE 702 may communicate with the RSU 708 to determine UEs located about the UE 702. In another aspect, the UE 702 may communicate with the RSU 708 to request a set of UEs to detect objects within a sensor area. In another object, the UE 702 may communicate with the RSU 708 and may allow the RSU 708 to coordinate the UEs 702, 704, and 706 to detect objects within a sensor area.

While the diagram 700 shows the UEs 702, 704, and 706 having detection directions 703, 705, and 707, respectively, each of the UEs may have more or less directions in which a set of sensors may detect objects about the vehicle. More or less UEs may be configured to coordinate with one another to sense objects within one or more sensor areas.

While a UE may be configured to detect one or more objects about the UE using a set of sensors, the UE may not be able to prioritize objects in one portion of a detection area vs. another portion of a detection area. For example, the UE 702 may be configured to detect objects within a detection area of the detection direction 703, but may not be configured to adjust a priority of objects detected within a sensor area of the detection area of the detection direction 703. In some aspects, a UE may be configured to adjust a priority of objects detected within a sensor area based on an indication of a driver-specified direction (DSD).

A UE may obtain a command including an indication of a DSD from a driver of a vehicle. The UE may then adjust a priority of objects detected within the sensor area of a set of sensors based on the indication of the DSD.

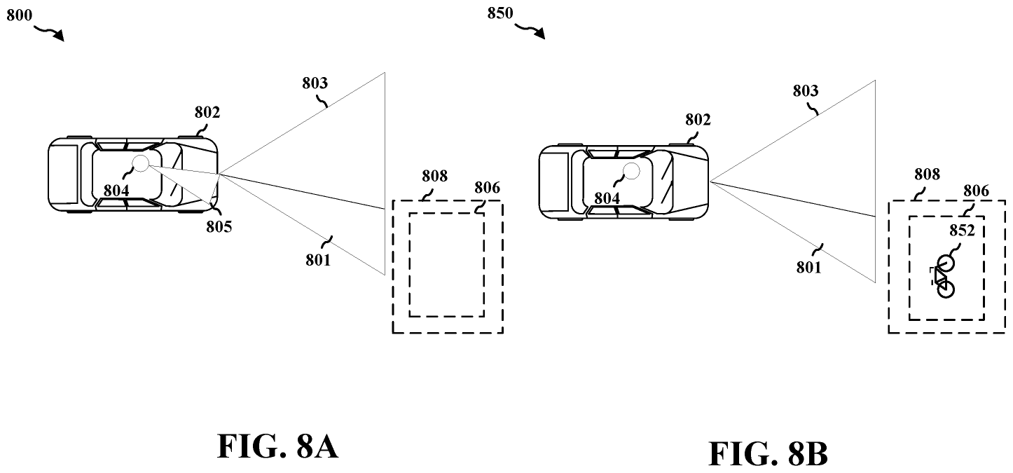

FIG. 8A is a diagram 800 illustrating example aspects of a UE 802 configured to obtain an indication of a DSD 805 from a driver 804. The DSD 805 may be obtained via a wired connection or a wireless connection. A driver monitoring system (DMS) may monitor actions of the driver 804 to receive an indication of the DSD 805 from the driver 804. In one aspect, a DSD 805 may be obtained via a microphone sensor that receives a verbal command from the driver 804, such as a command of “OK, car, tell me if there are any bikes on the right side.” Receipt of the first two words, “OK, car,” may trigger a processor to analyze the rest of the audio message for a command, the words “tell me” may trigger a processor to respond with an audio response, the words “if there are any bikes” may narrow the objects that the processor looks for to objects that share an association with a bicycle, and “on the right side” may narrow the sensor area for objects to be searched for within an area designated as the “right side” by the system, such as an area to the right of the driver of the vehicle or the right-most half of a sensor range of the vehicle. The system may semantically interpret a command, such as a verbal command or a typed command, from the driver 804 associated with the UE 802 in a plurality of ways. In another aspect, the UE 802 may detect a plurality of objects in the detection direction 803. The UE 802 may indicate the objects to the driver 804 in any suitable manner, for example by displaying a video of objects in the detection direction 803 on a screen, or by highlighting an area of a HUD of a vehicle associated with the UE 802. The driver 804 may input a command “monitor objects between the house and the truck.” Receipt of the word “monitor” may trigger a processor to prioritize tracking objects in the indicated area and not tracking objects outside of the indicated area. Receipt of the word “objects” may trigger a processor to analyze any recognizable object within the indicated area, as opposed to analyzing objects that are associated with a bicycle fingerprint or a truck fingerprint. Receipt of the phrase “between the house and the truck” may indicate the DSD 805 to be bounded by a house object and a truck object detected in any detection areas of the detection direction 803. In another aspect, the driver 804 may input a command “monitor the roadway between the house and the truck,” triggering the UE 802 to monitor objects bounded by a detected roadway object between a detected house object and a detected truck object. The UE 802 may be configured to recognize objects within a sensor based on one or more object fingerprints associated with different types of objects used to describe a DSD, such as a building, a dumpster/skip, a tree, or an edge of a road, in addition to different types of objects to monitor, such as a bicycle, a car, or a truck.

In one aspect, the DSD 805 may be obtained via a camera sensor that may receive a gesture from the driver 804, such as a gesture towards a portion of the car. The gesture may be, for example, a wave or a point or a tap. In one aspect, the DSD 805 may be obtained via a camera, LIDAR, SONAR, or thermal sensor that detects an eye gaze or a head direction of the driver 804. In some aspects, a first sensor may detect a head direction of the driver 804, and a second sensor may detect an eye gaze of the driver 804. The UE 802 may first determine a first zone of the detection area based on the head direction of the driver 804, and then determine a sub-zone within the first zone based on an eye gaze of the driver 804.

The UE 802 may have a detection direction 803 that indicates the areas about the UE 802 that a set of sensors of the UE 802 may monitor about the UE 802. The UE 802 may use the DSD 805 to select a sensor area 806 in the detection direction 803. The sensor area 806 may correspond with a detection sub-direction 801 within the detection direction 803. The UE 802 may adjust a priority of objects detected within the sensor area 806 based on the DSD 805. For example, the UE 802 may increase or decrease a priority of objects detected within the detection sub-direction 801 of the detection direction 803 based on the sensor area 806. In some aspects, the UE 802 may receive an indication of the sensor area 806 based on the DSD 805, and the UE 802 may monitor the sensor area 806 selected by the driver 804 via a set of sensors of the UE 802. In some aspects, the UE 802 may receive an indication of the sensor area 806 based on the DSD 805, and the UE 802 may select an area that is larger than the sensor area 806, such as the modified sensor area 808. For example, the driver 804 of the UE 802 may indicate the sensor area 806 for monitoring, and the UE 802 may select the modified sensor area 808 for monitoring, which is larger than the sensor area 806 selected by the driver 804 of the UE 802 by a factor (e.g., larger by 10%, or larger by 2 feet on each side), and may be centered on the sensor area 806 selected by the driver 804. The UE 802 may monitor the modified sensor area 808 using a set of sensors of the UE 802 based on the sensor area 806 indicated by the driver 804.

In some aspects, altering the priority of objects detected in a sub-direction, or a designated sensor area, may eliminate or isolate areas for monitoring. In one aspect the UE 802 may set a default priority of objects to be monitored in an area, such as all areas detected in the detection direction 803, to zero. In response to the driver 804 indicating a DSD 805, the UE 802 may increase a priority of objects to be monitored in all areas detected in the detection sub-direction 801 to one. This may exclude all areas within the detection direction 803 from being monitored with the exception of areas in the detection sub-direction 801 of the set of sensors of the UE 802. In another aspect, the UE 802 may set a default priority of objects to be monitored in an area, such as all areas detected in the detection direction 803, to one. In response to the driver 804 indicating a DSD 805, the UE 802 may decrease a priority of objects to be monitored in all areas detected in the detection sub-direction 801 to zero. This may exclude all areas within the detection sub-direction 801 from being monitored within the detection direction 803.

In some aspects, the UE 802 may communicate with other UEs, such as the UEs 702, 704, or 706 in FIG. 7, to detect and monitor objects within the sensor area 806 via a set of sensors of the UE 802. In some aspects, the UE 802 may detect and monitor a portion of the sensor area 806, and other UEs that communicate with the UE 802 may detect and monitor other, non-overlapping, portions of the sensor area 806. In other aspects, the UE 802 and other UEs, such as the UEs 702, 704, or 706 in FIG. 7, may be configured to monitor overlapping portions of the sensor area 806.

FIG. 8B is a diagram 850 illustrating example aspects of the UE 802 configured to monitor objects within the sensor area 806 or the modified sensor area 808 (“monitored sensor area”). In one aspect, the UE 802 may increase a priority of objects detected within the monitored sensor area based on the DSD 805. The UE 802 may detect an object 852 and may report it to the driver 804, for example via a speaker (e.g., the UE 802 may play a recording indicating that it detected a bicycle in the monitored sensor area) or via a display screen (e.g., the UE 802 may indicate the monitored sensor area in a display screen on the dashboard or a heads up display (HUD) projected on a windshield of the car, and may highlight the object 852 within the monitored sensor area). The UE 802 may monitor the object 852 and may report to the driver 804 when a status of the object 852 changes, for example if a speed of the object 852 changes, if the object 852 disappears from the monitored sensor area, or if a new object blocks a portion of the object 852 from being seen by the UE 802.

In some aspects, the UE 802 may monitor the object 852 in response to receiving a command from the driver 804. The UE 802 may monitor the object 852 within the monitored sensor area in conjunction with a set of other UEs, such as the UEs 702, 704, or 706 in FIG. 7. For example, in one aspect, the UE 802 may receive an audio command from a microphone sensor that records the sentence, “OK car, tell me if the bike starts moving.” Receipt of the first two words, “OK, car,” may trigger a processor to analyze the rest of the audio message for a command, the words “tell me” may trigger a processor to respond with an audio response, the words “if there the bike” may narrow the objects that the processor looks for to objects that share an association with a bicycle, and “starts moving” may narrow the types of object state changes to a movement from a state of rest to a state of motion.

In some aspects, the UE 802 may detect a plurality of bikes within the monitored sensor area. In response, the UE 802 may prompt the UE 802 for clarification. For example, the UE 802 may transmit an audio signal to a speaker of the UE 802 indicating the presence of a plurality of bikes in the sensor area 806, and may prompt the driver 804 to select one of the plurality of bikes in the sensor area with respect to the driver 804 for monitoring. In response, the driver 804 may output an indication of a selection of one of the plurality of bikes, for example via an audio command to “select the left-most bike” received by a microphone sensor, via a typed command to “select the largest bike” received by a keyboard, or via touching a representation of the bike to be monitored received by a touchscreen that shows an image of the monitored sensor area. The UE 802 may indicate differences between the plurality of objects monitored in the monitored sensor area in its query to the driver 804, for example differences in position (e.g., left bike, middle bike, right bike), differences in size (e.g., large bike, average bike, small bike), or differences in color (red bike, yellow bike, orange bike), which the driver 804 may use to select one of the objects in the monitored sensor area.

In some aspects, the UE 802 may be unable to detect an object indicated by the driver 804 of the UE 802. For example, the driver 804 of the UE 802 may indicate for the UE 802 to monitor the sensor area 806 for a bicycle, and the UE 802 may be unable to detect a bicycle in the monitored sensor area, for example if there is no bicycle in the area, if a blocking object is placed in between a set of sensors of the UE 802 and the object 852, or if the data from the set of sensors of the UE 802 may be corrupted. The UE 802 may indicate to the driver 804 of the UE 802 that the UE 802 is unable to detect the indicated object. In response, the driver 804 of the UE 802 may repeat the same instruction, or may provide an alternative instruction that allows the UE 802 to detect the object (e.g., by indicating a smaller sensor area to monitor, or by providing a more accurate description of the object to be monitored).

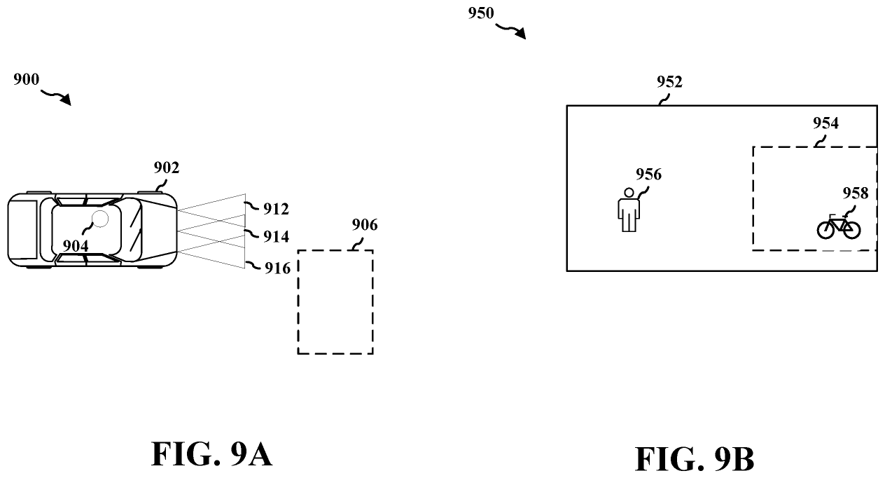

FIG. 9A is a diagram 900 illustrating an example of a UE 902 configured to indicate a sensor area 906 to the driver 904 of the UE 902. For example, the UE 902 may receive an indication from the driver 904 to monitor the sensor area 906. The UE 902 may have a plurality of headlights that illuminate various areas about the UE 902, such as the area 912, the area 914, and the area 916. In response to the UE 902 receiving an indication from the driver 904 to monitor the sensor area 906 from the driver 904, the UE 902 may illuminate the area 916 and may not illuminate the area 912 or the area 914, indicating to the driver 904 that it will be monitoring the area illuminated by the area 916.

The UE 902 may indicate to the driver 904 that it seeks confirmation of the selection of the sensor area 906, for example by playing a prompt through a speaker of the UE 902 the message, “Please confirm whether the illuminated area should be monitored.” The UE 902 may then receive a signal from the driver 904, such as an audio signal “confirmed” for confirming the area and “not confirmed” for not confirming the area, or a tactile signal of the driver 904 pressing an “OK” button for confirming the area and a “CANCEL” button for not confirming the area.

FIG. 9B is a diagram 950 illustrating an example of the UE 902 having a display 952 that may be used to display a detection area within the display 952. The display 952 may be a visual representation of a detection area of the UE 902, such as a display of a light camera or an infrared camera that the UE 902 may have of an area about the UE 902. The display 952 may indicate a plurality of objects, such as the object 956 and the object 958 about the UE 902. The UE 902 may highlight an area 954 of the display 952 to indicate to the driver 904 that the representation that is highlighted by the area 954 is selected as the area to monitor by the UE 902, and that the UE 902 wishes to obtain a confirmation of whether to adjust a priority of objects within the representation of the area 954. In response, the UE 902 may adjust a priority of the object 958 with respect to the object 956, for example by increasing or decreasing the priority of changes of state of the object 958 with respect to the object 956.

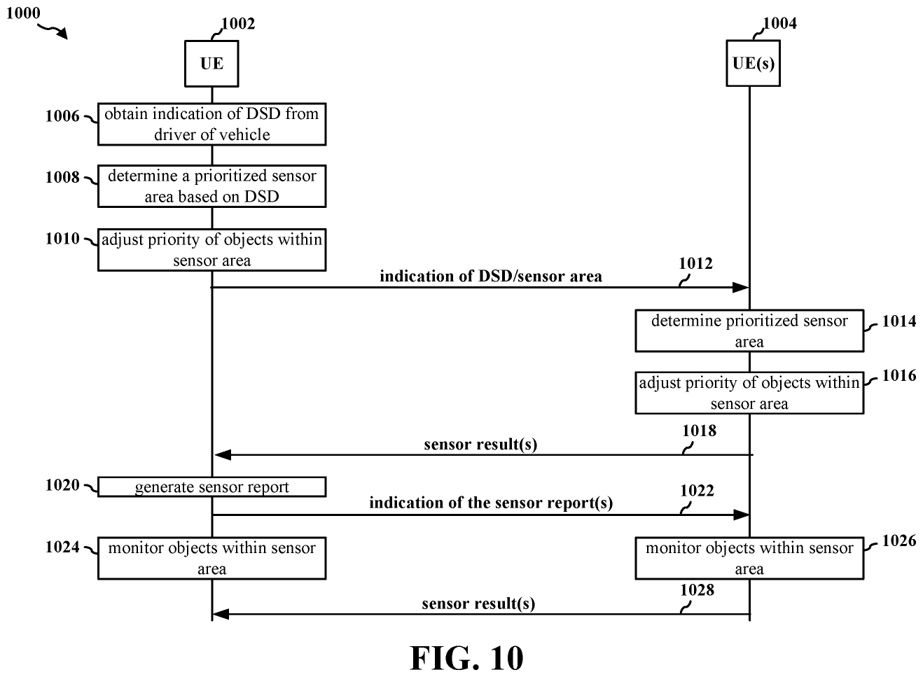

FIG. 10 is a connection flow diagram 1000 for a UE 1002 configured to sense objects within a sensor area by cooperating with a set of UEs 1004.

At 1006, the UE 1002 may obtain an indication of a DSD from a driver of a vehicle associated with the UE 1002. For example, the UE 1002 may use a DMS to monitor a driver of the vehicle associated with the UE 1002. The DMS may obtain a command that includes an indication of a DSD from the driver of the vehicle associated with the UE 1002. The UE 1002 may fuse one or more inputs from the driver of the vehicle associated with the UE 1002. For example, the UE 1002 may fuse keywords, a head direction, and/or a gaze direction of the driver in order to infer a DSD and/or objects to analyze about the UE 1002. In some aspects, the UE 1002 may fuse one or more inputs from the driver of the vehicle associated with the UE 1002 with one or more inputs from a set of sensors of the vehicle associated with the UE 1002, such as fusing a selection of a left-most bicycle with an input from a set of sensors that monitor a set of bicycles in a row from left to right from the perspective of the driver of the vehicle.

At 1008, the UE 1002 may determine a prioritized sensor area based on the DSD received from the driver of the vehicle associated with the UE 1002. The prioritized sensor area may be used to select a sub-area of a detection area of a set of sensors of the UE 1002. In some aspects, the UE 1002 may confirm the prioritized sensor area with the driver, for example by turning on specialized lights about the UE 1002 or by highlighting an area of a display of the UE 1002.

At 1010, the UE 1002 may adjust a priority of objects within the sensor area based on the prioritized sensor area. The UE 1002 may increase the priority of objects within the sensor area, or may decrease the priority of objects within the sensor area, or may monitor a selection of state changes of objects within or without the sensor area based on the command associated with the indication of the DSD from the driver of the vehicle associated with the UE 1002.

The UE 1002 may transmit an indication 1012 of the DSD or of the sensor area to the set of UEs 1004. The set of UEs 1004 may be a set of UEs 1004 that may have sensors that may have the ability to monitor the sensor area indicated by the DSD of the driver of the vehicle associated with the UE 1002.

At 1014, the set of UEs 1004 may determine the prioritized sensor area based on the indication 1012 of the DSD or of the sensor area. The prioritized sensor area determined by the set of UEs 1004 may be the same, or may be different than the prioritized sensor area determined by the UE 1002 at 1008, since the detection area of the set of UEs 1004 may be different than the detection area of the UE 1002.

At 1016, the set of UEs 1004 may adjust a priority of objects within the sensor area based on the prioritized sensor area, similar to the UE 1002 at 1010. The set of UEs 1004 may transmit a set of sensor results 1018 to the UE 1002. The UE 1002 may receive the set of sensor results 1018 from the set of UEs 1004.

At 1020, the UE 1002 may generate a sensor report based on the set of sensor results 1018 and the prioritized sensor area determined at 1008. For example, the UE 1002 may determine a total coverage area of a sensor area based on the indication of the DSD from the driver of the vehicle associated with the UE 1002 and the set of sensor results 1018. The UE 1002 may then determine what types of statuses to monitor for each of the UE 1002 and the set of UEs 1004 based on the generated sensor report. The UE 1002 may transmit an indication 1022 of the set of sensor reports to the set of UEs 1004. The set of UEs 1004 may receive the indication 1022 of the set of sensor reports.

At 1024, the UE 1002 may monitor objects within a prioritized sensor area based on the adjusted priority of objects within the sensor area at 1010 or based on the generated sensor report at 1020. At 1026, the set of UEs 1004 may monitor objects within a set of prioritized sensor areas based on the adjusted priority of objects within the sensor area indicated by the indication 1012 of the DSD or of the sensor area or the indication 1022 of the set of sensor reports. The prioritized sensor area monitored by the UE 1002 may be different, the same, or overlapping with the set of prioritized sensor areas monitored by the set of UEs 1004. The set of UEs 1004 may transmit a set of sensor results 1028 to the UE 1002. The UE 1002 may receive the set of sensor results 1028.

The UE 1002 may be configured to notify the driver associated with the UE 1002 based on the monitoring results at 1024 and based on the set of sensor results 1028 received from the set of UEs 1004. For example, the UE 1002 may notify the driver associated with the UE 1002 if a new object enters one of the prioritized sensor areas, if an object in one of the prioritized sensor areas is blocked, or if a projected path of one of the objects in one of the prioritized sensor areas changes to a different projected path by a threshold amount (e.g., by more than half a meter, or by more than 10%).

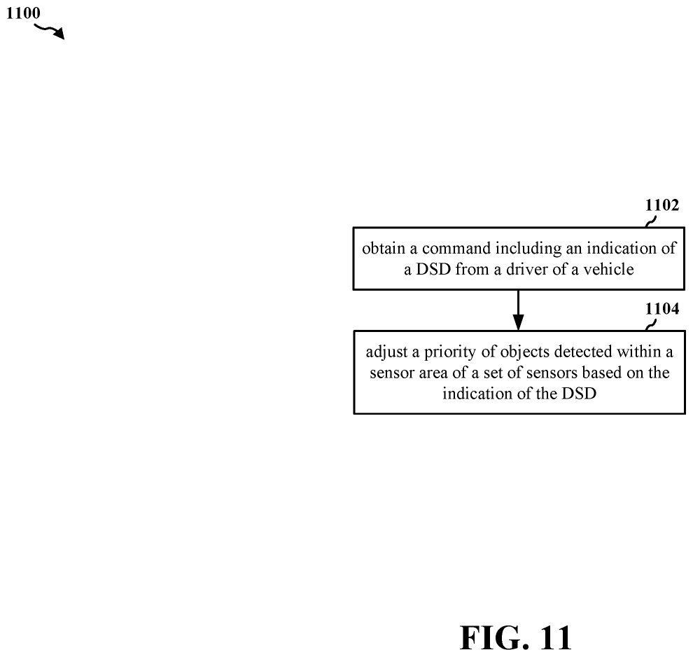

FIG. 11 is a flowchart 1100 of a method of wireless communication. The method may be performed by a UE (e.g., the UE 104, the UE 350, the UE 502, the UE 504, the UE 506, the UE 508, the UE 702, the UE 704, the UE 706, the UE 802, the UE 902, the UE 1002, the UE 1004; the RSU 107, the RSU 507; the apparatus 1404). At 1102, the UE may obtain a command including an indication of a DSD from a driver of a vehicle. For example, 1102 may be performed by the UE 1002 in FIG. 10 which may, at 1006, obtain a command including an indication of a DSD from a driver of a vehicle. Moreover, 1102 may be performed by the component 198 in FIG. 1, 3, 5, 7, or 14.

At 1104, the UE may adjust a priority of objects detected within a sensor area of a set of sensors based on the indication of the DSD. For example, 1104 may be performed by the UE 1002 in FIG. 10 which, at 1010, may adjust a priority of objects detected within a sensor area of a set of sensors based on the indication of the DSD. Moreover, 1104 may be performed by the component 198 in FIG. 1, 3, 5, 7, or 14.

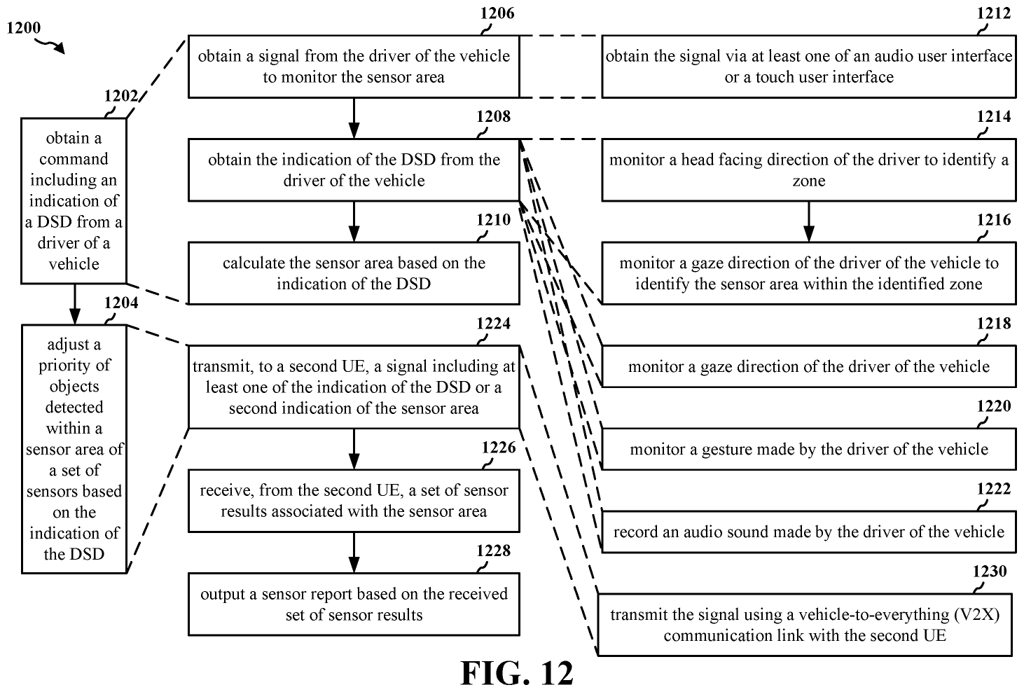

FIG. 12 is a flowchart 1200 of a method of wireless communication. The method may be performed by a UE (e.g., the UE 104, the UE 350, the UE 502, the UE 504, the UE 506, the UE 508, the UE 702, the UE 704, the UE 706, the UE 802, the UE 902, the UE 1002, the UE 1004; the RSU 107, the RSU 507; the apparatus 1404). At 1202, the UE may obtain a command including an indication of a DSD from a driver of a vehicle. For example, 1202 may be performed by the UE 1002 in FIG. 10 which may, at 1006, obtain a command including an indication of a DSD from a driver of a vehicle. Moreover, 1202 may be performed by the component 198 in FIG. 1, 3, 5, 7, or 14.

At 1204, the UE may adjust a priority of objects detected within a sensor area of a set of sensors based on the indication of the DSD. For example, 1204 may be performed by the UE 1002 in FIG. 10 which, at 1010, may adjust a priority of objects detected within a sensor area of a set of sensors based on the indication of the DSD. Moreover, 1204 may be performed by the component 198 in FIG. 1, 3, 5, 7, or 14.

At 1206, the UE may obtain a signal from the driver of the vehicle to monitor the sensor area. For example, 1206 may be performed by the UE 1002 in FIG. 10 which, at 1010, may obtain a signal from the driver of the vehicle to monitor the sensor area. Moreover, 1206 may be performed by the component 198 in FIG. 1, 3, 5, 7, or 14.

At 1208, the UE may obtain the indication of the DSD from the driver of the vehicle. For example, 1208 may be performed by the UE 1002 in FIG. 10 which, at 1010, may obtain the indication of the DSD from the driver of the vehicle. Moreover, 1208 may be performed by the component 198 in FIG. 1, 3, 5, 7, or 14.

At 1210, the UE may calculate the sensor area based on the indication of the DSD. For example, 1210 may be performed by the UE 1002 in FIG. 10 which, at 1010, may calculate the sensor area based on the indication of the DSD. Moreover, 1210 may be performed by the component 198 in FIG. 1, 3, 5, 7, or 14.

At 1212, the UE may obtain the signal via at least one of an audio user interface or a touch user interface. For example, 1212 may be performed by the UE 1002 in FIG. 10 which, at 1010, may obtain the signal via at least one of an audio user interface or a touch user interface. Moreover, 1212 may be performed by the component 198 in FIG. 1, 3, 5, 7, or 14.

At 1214, the UE may monitor a head facing direction of the driver to identify a zone. For example, 1214 may be performed by the UE 1002 in FIG. 10 which, at 1010, may monitor a head facing direction of the driver to identify a zone. Moreover, 1214 may be performed by the component 198 in FIG. 1, 3, 5, 7, or 14.

At 1216, the UE may monitor a gaze direction of the driver of the vehicle to identify the sensor area within the identified zone. For example, 1216 may be performed by the UE 1002 in FIG. 10 which, at 1010, may monitor a gaze direction of the driver of the vehicle to identify the sensor area within the identified zone. Moreover, 1216 may be performed by the component 198 in FIG. 1, 3, 5, 7, or 14.

At 1218, the UE may monitor a gaze direction of the driver of the vehicle. For example, 1218 may be performed by the UE 1002 in FIG. 10 which, at 1010, may monitor a gaze direction of the driver of the vehicle. Moreover, 1218 may be performed by the component 198 in FIG. 1, 3, 5, 7, or 14.

At 1220, the UE may monitor a gesture made by the driver of the vehicle. For example, 1220 may be performed by the UE 1002 in FIG. 10 which, at 1010, may monitor a gesture made by the driver of the vehicle. Moreover, 1220 may be performed by the component 198 in FIG. 1, 3, 5, 7, or 14.

At 1222, the UE may record an audio sound made by the driver of the vehicle. For example, 1222 may be performed by the UE 1002 in FIG. 10 which, at 1010, may record an audio sound made by the driver of the vehicle. Moreover, 1222 may be performed by the component 198 in FIG. 1, 3, 5, 7, or 14.

At 1224, the UE may transmit, to a second UE, a signal including at least one of the indication of the DSD or a second indication of the sensor area. For example, 1224 may be performed by the UE 1002 in FIG. 10 which, at 1010, may transmit, to a second UE, a signal including at least one of the indication of the DSD or a second indication of the sensor area. Moreover, 1224 may be performed by the component 198 in FIG. 1, 3, 5, 7, or 14.

At 1226, the UE may receive, from the second UE, a set of sensor results associated with the sensor area. For example, 1226 may be performed by the UE 1002 in FIG. 10 which, at 1010, may receive, from the second UE, a set of sensor results associated with the sensor area. Moreover, 1226 may be performed by the component 198 in FIG. 1, 3. 5, 7, or 14.

At 1228, the UE may output a sensor report based on the received set of sensor results. For example, 1228 may be performed by the UE 1002 in FIG. 10 which, at 1010, may output a sensor report based on the received set of sensor results. Moreover, 1228 may be performed by the component 198 in FIG. 1, 3, 5, 7, or 14.

At 1230, the UE may transmit the signal using a vehicle-to-everything (V2X) communication link with the second UE. For example, 1230 may be performed by the UE 1002 in FIG. 10 which, at 1010, may transmit the signal using a vehicle-to-everything (V2X) communication link with the second UE. Moreover, 1230 may be performed by the component 198 in FIG. 1, 3, 5, 7, or 14.

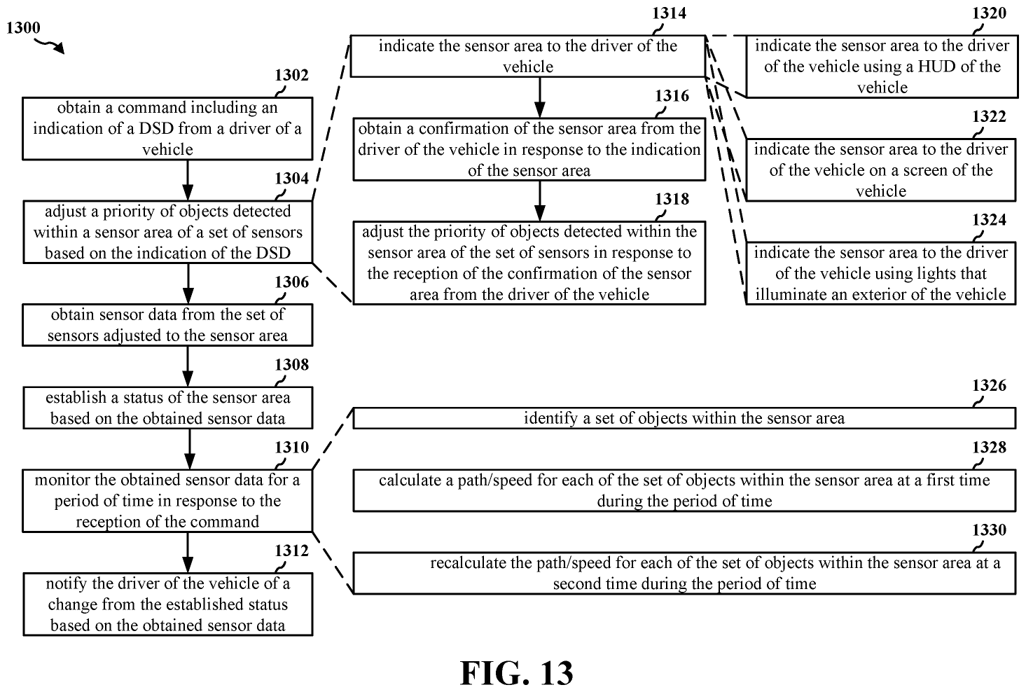

FIG. 13 is a flowchart 1300 of a method of wireless communication. The method may be performed by a UE (e.g., the UE 104, the UE 350, the UE 502, the UE 504, the UE 506, the UE 508, the UE 702, the UE 704, the UE 706, the UE 802, the UE 902, the UE 1002, the UE 1004; the RSU 107, the RSU 507; the apparatus 1404). At 1302, the UE may obtain a command including an indication of a DSD from a driver of a vehicle. For example, 1302 may be performed by the UE 1002 in FIG. 10 which may, at 1006, obtain a command including an indication of a DSD from a driver of a vehicle. Moreover, 1302 may be performed by the component 198 in FIG. 1, 3, 5, 7, or 14.

At 1304, the UE may adjust a priority of objects detected within a sensor area of a set of sensors based on the indication of the DSD. For example, 1304 may be performed by the UE 1002 in FIG. 10 which, at 1010, may adjust a priority of objects detected within a sensor area of a set of sensors based on the indication of the DSD. Moreover, 1304 may be performed by the component 198 in FIG. 1, 3, 5, 7, or 14.

At 1306, the UE may obtain sensor data from the set of sensors adjusted to the sensor area. For example, 1306 may be performed by the UE 1002 in FIG. 10 which, at 1010, may obtain sensor data from the set of sensors adjusted to the sensor area. Moreover, 1306 may be performed by the component 198 in FIG. 1, 3, 5, 7, or 14.

At 1308, the UE may establish a status of the sensor area based on the obtained sensor data. For example, 1308 may be performed by the UE 1002 in FIG. 10 which, at 1010, may establish a status of the sensor area based on the obtained sensor data. Moreover, 1308 may be performed by the component 198 in FIG. 1, 3, 5, 7, or 14.

At 1310, the UE may monitor the obtained sensor data for a period of time in response to the reception of the command. For example, 1310 may be performed by the UE 1002 in FIG. 10 which, at 1010, may monitor the obtained sensor data for a period of time in response to the reception of the command. Moreover, 1310 may be performed by the component 198 in FIG. 1, 3, 5, 7, or 14.

At 1312, the UE may notify the driver of the vehicle of a change from the established status based on the obtained sensor data. For example, 1312 may be performed by the UE 1002 in FIG. 10 which, at 1010, may notify the driver of the vehicle of a change from the established status based on the obtained sensor data. Moreover, 1312 may be performed by the component 198 in FIG. 1, 3, 5, 7, or 14.

At 1314, the UE may indicate the sensor area to the driver of the vehicle. For example, 1314 may be performed by the UE 1002 in FIG. 10 which, at 1010, may indicate the sensor area to the driver of the vehicle. Moreover, 1314 may be performed by the component 198 in FIG. 1, 3, 5, 7, or 14.

At 1316, the UE may obtain a confirmation of the sensor area from the driver of the vehicle in response to the indication of the sensor area. For example, 1316 may be performed by the UE 1002 in FIG. 10 which, at 1010, may obtain a confirmation of the sensor area from the driver of the vehicle in response to the indication of the sensor area. Moreover, 1316 may be performed by the component 198 in FIG. 1, 3, 5, 7, or 14.

At 1318, the UE may adjust the priority of objects detected within the sensor area of the set of sensors in response to the reception of the confirmation of the sensor area from the driver of the vehicle. For example, 1318 may be performed by the UE 1002 in FIG. 10 which, at 1010, may adjust the priority of objects detected within the sensor area of the set of sensors in response to the reception of the confirmation of the sensor area from the driver of the vehicle. Moreover, 1318 may be performed by the component 198 in FIG. 1, 3, 5, 7, or 14.

At 1320, the UE may indicate the sensor area to the driver of the vehicle using a HUD of the vehicle. For example, 1320 may be performed by the UE 1002 in FIG. 10 which, at 1010, may indicate the sensor area to the driver of the vehicle using a HUD of the vehicle. Moreover, 1320 may be performed by the component 198 in FIG. 1, 3, 5, 7, or 14.

At 1322, the UE may indicate the sensor area to the driver of the vehicle on a screen of the vehicle. For example, 1322 may be performed by the UE 1002 in FIG. 10 which, at 1010, may indicate the sensor area to the driver of the vehicle on a screen of the vehicle. Moreover, 1322 may be performed by the component 198 in FIG. 1, 3, 5, 7, or 14.

At 1324, the UE may indicate the sensor area to the driver of the vehicle using lights that illuminate an exterior of the vehicle. For example, 1324 may be performed by the UE 1002 in FIG. 10 which, at 1010, may indicate the sensor area to the driver of the vehicle using lights that illuminate an exterior of the vehicle. Moreover, 1324 may be performed by the component 198 in FIG. 1, 3, 5, 7, or 14.

At 1326, the UE may identify a set of objects within the sensor area. For example, 1326 may be performed by the UE 1002 in FIG. 10 which, at 1010, may identify a set of objects within the sensor area. Moreover, 1326 may be performed by the component 198 in FIG. 1, 3, 5, 7, or 14.

At 1328, the UE may calculate a path/speed for each of the set of objects within the sensor area at a first time during the period of time. For example, 1328 may be performed by the UE 1002 in FIG. 10 which, at 1010, may calculate a path/speed for each of the set of objects within the sensor area at a first time during the period of time. Moreover, 1328 may be performed by the component 198 in FIG. 1, 3, 5, 7, or 14.

At 1330, the UE may recalculate the path/speed for each of the set of objects within the sensor area at a second time during the period of time. For example, 1330 may be performed by the UE 1002 in FIG. 10 which, at 1010, may recalculate the path/speed for each of the set of objects within the sensor area at a second time during the period of time. Moreover, 1330 may be performed by the component 198 in FIG. 1, 3. 5, 7, or 14.

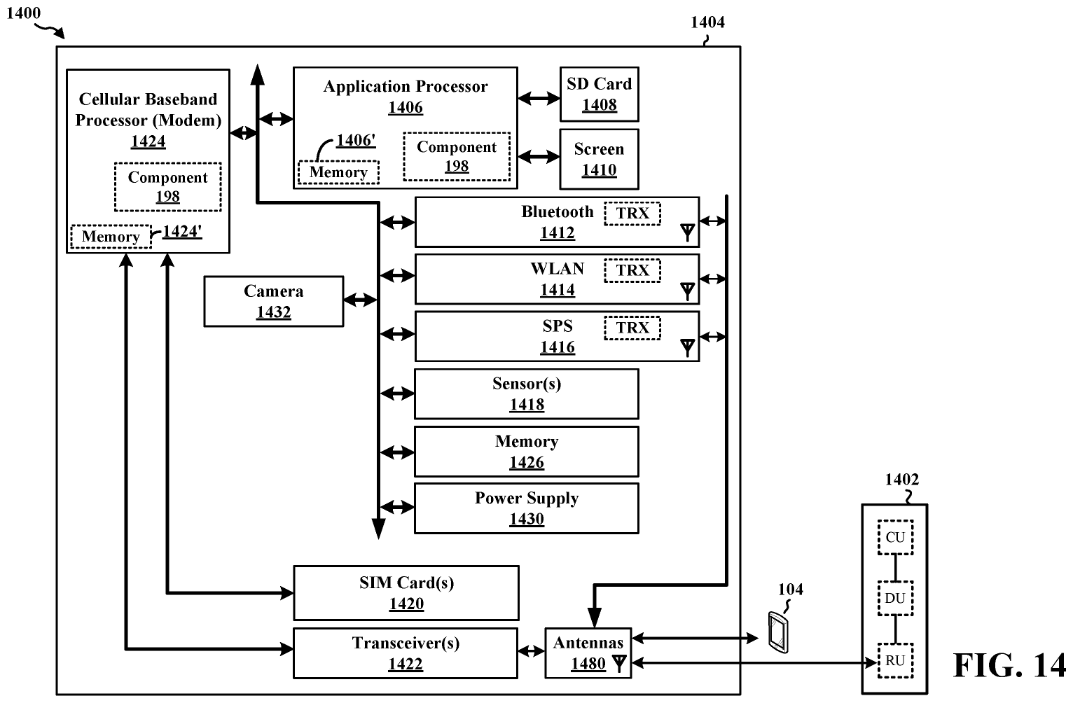

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio sensor, microphone, thermal sensor, driver monitoring system (DMS), motion sensor, camera, eye-movement sensor, and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (Rx)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the Tx processor 368, the Rx processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see UE 350 of FIG. 3) and include the additional modules of the apparatus 1404.

As discussed supra, the component 198 may be configured to obtain a DSD from a driver of a vehicle. The component 198 may be configured to adjust a priority of objects detected within a sensor area of a set of sensors based on the indication of the DSD. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, may include means for obtaining a command including an indication of a DSD from a driver of a vehicle. The apparatus 1404 may include means for adjusting a priority of objects detected within a sensor area of a set of sensors based on the indication of the DSD. The set of sensors may include at least one of a LIDAR sensor, a RADAR sensor, a SONAR sensor, a thermal sensor, a microphone, or a camera. The apparatus 1404 may include means for obtaining the command including the indication of the DSD by obtaining a signal from the driver of the vehicle to monitor the sensor area. The apparatus 1404 may include means for obtaining the command including the indication of the DSD by obtaining the indication of the DSD from the driver of the vehicle. The apparatus 1404 may include means for obtaining the command including the indication of the DSD by calculating the sensor area based on the indication of the DSD. The apparatus 1404 may include means for obtaining the signal from the driver of the vehicle by obtaining the signal via at least one of an audio user interface or a touch user interface. The apparatus 1404 may include means for obtaining the indication of the DSD from the driver of the vehicle by monitoring a head facing direction of the driver to identify a zone. The apparatus 1404 may include means for obtaining the indication of the DSD from the driver of the vehicle by monitoring a gaze direction of the driver of the vehicle to identify the sensor area within the identified zone. The apparatus 1404 may include means for obtaining the indication of the DSD from the driver of the vehicle by monitoring a gaze direction of the driver of the vehicle. The apparatus 1404 may include means for obtaining the indication of the DSD from the driver of the vehicle by monitoring a gesture made by the driver of the vehicle. The apparatus 1404 may include means for obtaining the indication of the DSD from the driver of the vehicle by recording an audio sound made by the driver of the vehicle. The apparatus 1404 may include means for adjusting the direction of the set of sensors by transmitting, to a second UE, a signal including at least one of the indication of the DSD or a second indication of the sensor area. The apparatus 1404 may include means for receiving, from the second UE, a set of sensor results associated with the sensor area. The apparatus 1404 may include means for outputting a sensor report based on the received set of sensor results. The apparatus 1404 may include means for transmitting the signal to the second UE by transmitting the signal using a V2X communication link with the second UE. The apparatus 1404 may include means for adjusting the priority of objects detected within the sensor area of the set of sensors by indicating the sensor area to the driver of the vehicle. The apparatus 1404 may include means for adjusting the priority of objects detected within the sensor area of the set of sensors by obtaining a confirmation of the sensor area from the driver of the vehicle in response to the indication of the sensor area. The apparatus 1404 may include means for adjusting the priority of objects detected within the sensor area of the set of sensors by adjusting the priority of objects detected within the sensor area of the set of sensors in response to the reception of the confirmation of the sensor area from the driver of the vehicle. The apparatus 1404 may include means for indicating the sensor area to the driver of the vehicle by indicating the sensor area to the driver of the vehicle using a HUD of the vehicle. The apparatus 1404 may include means for indicating the sensor area to the driver of the vehicle by indicating the sensor area to the driver of the vehicle on a screen of the vehicle. The apparatus 1404 may include means for indicating the sensor area to the driver of the vehicle by indicating the sensor area to the driver of the vehicle using lights that illuminate an exterior of the vehicle. The apparatus 1404 may include means for obtaining sensor data from the set of sensors adjusted to the sensor area. The apparatus 1404 may include means for establishing a status of the sensor area based on the obtained sensor data. The apparatus 1404 may include means for monitoring the obtained sensor data for a period of time in response to the reception of the command. The apparatus 1404 may include means for notifying the driver of the vehicle of a change from the established status based on the obtained sensor data. The change in the status may include a new object status in the sensor area relative to the established status. The change in the status may include a new obstacle in the sensor area relative to the established status. the change in the status may include an inability to sense a portion of the sensor area relative to the established status. The apparatus 1404 may include means for monitoring the obtained sensor data for the period of time by identifying a set of objects within the sensor area. The apparatus 1404 may include means for monitoring the obtained sensor data for the period of time by calculating a path for each of the set of objects within the sensor area at a first time during the period of time. The apparatus 1404 may include means for monitoring the obtained sensor data for the period of time by recalculating the path for each of the set of objects within the sensor area at a second time during the period of time. The apparatus 1404 may include means for monitoring the obtained sensor data for the period of time by identifying a set of objects within the sensor area. The apparatus 1404 may include means for monitoring the obtained sensor data for the period of time by calculating a speed for each of the set of objects within the sensor area at a first time during the period of time. The apparatus 1404 may include means for monitoring the obtained sensor data for the period of time by recalculating the speed for each of the set of objects within the sensor area at a second time during the period of time. The means may be the component 198 of the apparatus 1404 configured to perform the functions recited by the means. As described supra, the apparatus 1404 may include the Tx processor 368, the Rx processor 356, and the controller/processor 359. As such, in one configuration, the means may be the Tx processor 368, the Rx processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data via a wireless device, for example with a transceiver, or may send the data to a device that transmits the data. A device configured to “obtain” data, such as a transmission, signal, or message, may receive the data via a wireless device, for example with a transceiver, or may obtain the data from a device that receives the data.

The following aspects are illustrative only and may be combined with other aspects or teachings described herein, without limitation.

Aspect 1 is a method of communication at a UE, where the method may include obtaining a command including an indication of a DSD from a driver of a vehicle. The method may include adjusting a priority of objects detected within a sensor area of a set of sensors based on the indication of the DSD.

Aspect 2 is the method of aspect 1, where the set of sensors may include at least one of a LIDAR sensor, a RADAR sensor, a SONAR sensor, a thermal sensor, a microphone, or a camera.

Aspect 3 is the method of either of aspects 1 or 2, where obtaining the command including the indication of the DSD may include obtaining a signal from the driver of the vehicle to monitor the sensor area. Obtaining the command including the indication of the DSD may include obtaining the indication of the DSD from the driver of the vehicle. Obtaining the command including the indication of the DSD may include calculating the sensor area based on the indication of the DSD.

Aspect 4 is the method of aspect 3, where obtaining the signal from the driver of the vehicle may include obtaining the signal via at least one of an audio user interface or a touch user interface.

Aspect 5 is the method of either of aspects 3 or 4, where obtaining the indication of the DSD from the driver of the vehicle may include monitoring a head facing direction of the driver to identify a zone. Obtaining the indication of the DSD from the driver of the vehicle may include monitoring a gaze direction of the driver of the vehicle to identify the sensor area within the identified zone.

Aspect 6 is the method of any of aspects 3 to 5, where obtaining the indication of the DSD from the driver of the vehicle may include monitoring a gaze direction of the driver of the vehicle. Obtaining the indication of the DSD from the driver of the vehicle may include monitoring a gesture made by the driver of the vehicle. Obtaining the indication of the DSD from the driver of the vehicle may include recording an audio sound made by the driver of the vehicle.

Aspect 7 is the method of any of aspects 1 to 6, where adjusting the direction of the set of sensors may include transmitting, to a second UE, a signal including at least one of the indication of the DSD or a second indication of the sensor area.

Aspect 8 is the method of aspect 7, where the method may include receiving, from the second UE, a set of sensor results associated with the sensor area. The method may include outputting a sensor report based on the received set of sensor results.

Aspect 9 is the method of either of aspects 7 or 8, where transmitting the signal to the second UE may include transmitting the signal using a V2X communication link with the second UE.

Aspect 10 is the method of any of aspects 1 to 9, where adjusting the priority of objects detected within the sensor area of the set of sensors may include indicating the sensor area to the driver of the vehicle. Adjusting the priority of objects detected within the sensor area of the set of sensors may include obtaining a confirmation of the sensor area from the driver of the vehicle in response to the indication of the sensor area. Adjusting the priority of objects detected within the sensor area of the set of sensors may include adjusting the priority of objects detected within the sensor area of the set of sensors in response to the reception of the confirmation of the sensor area from the driver of the vehicle.

Aspect 11 is the method of aspect 10, where indicating the sensor area to the driver of the vehicle may include indicating the sensor area to the driver of the vehicle using a HUD of the vehicle. Indicating the sensor area to the driver of the vehicle may include indicating the sensor area to the driver of the vehicle on a screen of the vehicle. Indicating the sensor area to the driver of the vehicle may include indicating the sensor area to the driver of the vehicle using lights that illuminate an exterior of the vehicle.

Aspect 12 is the method of any of aspects 1 to 11, where the method may include obtaining sensor data from the set of sensors adjusted to the sensor area. The method may include establishing a status of the sensor area based on the obtained sensor data. The method may include monitoring the obtained sensor data for a period of time in response to the reception of the command. The method may include notifying the driver of the vehicle of a change from the established status based on the obtained sensor data.

Aspect 13 is the method of aspect 12, where the change in the status may include a new object status in the sensor area relative to the established status. The change in the status may include a new obstacle in the sensor area relative to the established status. the change in the status may include an inability to sense a portion of the sensor area relative to the established status.

Aspect 14 is the method of either of aspects 12 or 13, where monitoring the obtained sensor data for the period of time may include identifying a set of objects within the sensor area. Monitoring the obtained sensor data for the period of time may include calculating a path for each of the set of objects within the sensor area at a first time during the period of time. Monitoring the obtained sensor data for the period of time may include recalculating the path for each of the set of objects within the sensor area at a second time during the period of time.

Aspect 15 is the method of any of aspects 12 to 14, where monitoring the obtained sensor data for the period of time may include identifying a set of objects within the sensor area. Monitoring the obtained sensor data for the period of time may include calculating a speed for each of the set of objects within the sensor area at a first time during the period of time. Monitoring the obtained sensor data for the period of time may include recalculating the speed for each of the set of objects within the sensor area at a second time during the period of time.

Aspect 16 is an apparatus for wireless communication, including: a memory; and at least one processor coupled to the memory and, based at least in part on information stored in the memory, the at least one processor is configured to implement any of aspects 1 to 15.

Aspect 17 is the apparatus of aspect 16, further including at least one of an antenna or a transceiver coupled to the at least one processor.

Aspect 18 is an apparatus for wireless communication including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for communication at a user equipment (UE), comprising:
a memory; and
at least one processor coupled to the memory and, based at least in part on information stored in the memory, the at least one processor is configured to:
obtain a command comprising an indication of a driver-specified direction (DSD) from a driver of a vehicle; and
adjust a priority of objects detected within a sensor area of a set of sensors based on the indication of the DSD.

2. The apparatus of claim 1, wherein the set of sensors comprises at least one of a light detection and ranging (LIDAR) sensor, a radio detection and ranging (RADAR) sensor, a sound navigation and ranging (SONAR) sensor, a thermal sensor, a microphone, or a camera.

3. The apparatus of claim 1, wherein, to obtain the command comprising the indication of the DSD, the at least one processor is configured to:
obtain a signal from the driver of the vehicle to monitor the sensor area;
obtain the indication of the DSD from the driver of the vehicle; and
calculate the sensor area based on the indication of the DSD.

4. The apparatus of claim 3, wherein, to obtain the signal from the driver of the vehicle, the at least one processor is configured to:
obtain the signal via at least one of an audio user interface or a touch user interface.

5. The apparatus of claim 3, wherein, to obtain the indication of the DSD from the driver of the vehicle, the at least one processor is configured to:
monitor a head facing direction of the driver to identify a zone; and
monitor a gaze direction of the driver of the vehicle to identify the sensor area within the identified zone.

6. The apparatus of claim 3, wherein, to obtain the indication of the DSD from the driver of the vehicle, the at least one processor is configured to:
monitor a gaze direction of the driver of the vehicle;
monitor a gesture made by the driver of the vehicle; or
record an audio sound made by the driver of the vehicle.

7. The apparatus of claim 1, wherein, to adjust the priority of objects detected within the sensor area, the at least one processor is configured to:
transmit, to a second UE, a signal comprising at least one of the indication of the DSD or a second indication of the sensor area.

8. The apparatus of claim 7, the at least one processor is further configured to:
receive, from the second UE, a set of sensor results associated with the sensor area; and
output a sensor report based on the received set of sensor results.

9. The apparatus of claim 7, wherein, to transmit the signal to the second UE, the at least one processor is configured to:
transmit the signal using a vehicle-to-everything (V2X) communication link with the second UE.

10. The apparatus of claim 7, further comprising a transceiver coupled to the at least one processor, wherein, to transmit the signal, the at least one processor is configured to:
transmit, to the second UE via the transceiver, the signal comprising at least one of the indication of the DSD or the second indication of the sensor area.

11. The apparatus of claim 1, wherein, to adjust the priority of objects detected within the sensor area of the set of sensors, the at least one processor is configured to:
indicate the sensor area to the driver of the vehicle;
obtain a confirmation of the sensor area from the driver of the vehicle in response to the indication of the sensor area; and
adjust the priority of objects detected within the sensor area of the set of sensors in response to obtaining of the confirmation of the sensor area from the driver of the vehicle.

12. The apparatus of claim 11, wherein, to indicate the sensor area to the driver of the vehicle, the at least one processor is configured to:
indicate the sensor area to the driver of the vehicle using a heads up display (HUD) of the vehicle;
indicate the sensor area to the driver of the vehicle on a screen of the vehicle; or
indicate the sensor area to the driver of the vehicle using lights that illuminate an exterior of the vehicle.

13. The apparatus of claim 1, wherein the at least one processor is further configured to:
obtain sensor data from the set of sensors adjusted to the sensor area;
establish a status of the sensor area based on the obtained sensor data;
monitor the obtained sensor data for a period of time in response to obtaining the command; and
notify the driver of the vehicle of a change from the established status based on the obtained sensor data.

14. The apparatus of claim 13, wherein the change in the status comprises at least one of:
a new object status in the sensor area relative to the established status;
a new obstacle in the sensor area relative to the established status; or
an inability to sense a portion of the sensor area relative to the established status.

15. The apparatus of claim 13, wherein, to monitor the obtained sensor data for the period of time, the at least one processor is configured to:
identify a set of objects within the sensor area;
calculate a path for each of the set of objects within the sensor area at a first time during the period of time; and
recalculate the path for each of the set of objects within the sensor area at a second time during the period of time.

16. The apparatus of claim 13, wherein, to monitor the obtained sensor data for the period of time, the at least one processor is configured to:
identify a set of objects within the sensor area;
calculate a speed for each of the set of objects within the sensor area at a first time during the period of time; and
recalculate the speed for each of the set of objects within the sensor area at a second time during the period of time.

17. A method of communication at a user equipment (UE), comprising:
obtaining a command comprising an indication of a driver-specified direction (DSD) from a driver of a vehicle; and
adjusting a priority of objects detected within a sensor area of a set of sensors based on the indication of the DSD.

18. The method of claim 17, wherein the set of sensors comprises at least one of a light detection and ranging (LIDAR) sensor, a radio detection and ranging (RADAR) sensor, a sound navigation and ranging (SONAR) sensor, a thermal sensor, a microphone, or a camera.

19. The method of claim 17, wherein obtaining the command comprising the indication of the DSD comprises:
obtaining a signal from the driver of the vehicle to monitor the sensor area;
obtaining the indication of the DSD from the driver of the vehicle; and
calculating the sensor area based on the indication of the DSD.

20. The method of claim 19, wherein obtaining the signal from the driver of the vehicle comprises obtaining the signal via at least one of an audio user interface or a touch user interface.

21. The method of claim 19, wherein obtaining the indication of the DSD from the driver of the vehicle comprises:
monitoring a head facing direction of the driver to identify a zone; and
monitoring a gaze direction of the driver of the vehicle to identify the sensor area within the identified zone.

22. The method of claim 19, wherein obtaining the indication of the DSD from the driver of the vehicle comprises at least one of:
monitoring a gaze direction of the driver of the vehicle;
monitoring a gesture made by the driver of the vehicle; or
recording an audio sound made by the driver of the vehicle.

23. The method of claim 17, wherein adjusting the priority of objects detected within the sensor area comprises:
transmitting, to a second UE, a signal comprising at least one of the indication of the DSD or a second indication of the sensor area.

24. The method of claim 23, further comprising:
receiving, from the second UE, a set of sensor results associated with the sensor area; and
outputting a sensor report based on the received set of sensor results.

25. The method of claim 23, wherein transmitting the signal to the second UE comprises transmitting the signal using a vehicle-to-everything (V2X) communication link with the second UE.

26. The method of claim 25, wherein adjusting the priority of objects detected within the sensor area of the set of sensors comprises:
indicating the sensor area to the driver of the vehicle;
obtaining a confirmation of the sensor area from the driver of the vehicle in response to the indication of the sensor area; and
adjusting the priority of objects detected within the sensor area of the set of sensors in response to obtaining the confirmation of the sensor area from the driver of the vehicle.

27. The method of claim 25, wherein indicating the sensor area to the driver of the vehicle comprises at least one of:
indicating the sensor area to the driver of the vehicle using a heads up display (HUD) of the vehicle;
indicating the sensor area to the driver of the vehicle on a screen of the vehicle; or
indicating the sensor area to the driver of the vehicle using lights that illuminate an exterior of the vehicle.

28. The method of claim 17, further comprising:
obtaining sensor data from the set of sensors adjusted to the sensor area;
establishing a status of the sensor area based on the obtained sensor data;
monitoring the obtained sensor data for a period of time in response to obtaining the command; and
notifying the driver of the vehicle of a change from the established status based on the obtained sensor data.

29. An apparatus for communication at a user equipment (UE), comprising:
means for obtaining a command comprising an indication of a driver-specified direction (DSD) from a driver of a vehicle; and
means for adjusting a priority of objects detected within a sensor area of a set of sensors based on the indication of the DSD.

30. A computer-readable medium storing computer executable code at a user equipment (UE), the code when executed by a processor causes the processor to:
obtain a command comprising an indication of a driver-specified direction (DSD) from a driver of a vehicle; and
adjust a priority of objects detected within a sensor area of a set of sensors based on the indication of the DSD.
